(19) United States
(12) Patent Application Publication
(10) Pub. No.: US 2025/0125066 A1
(43) Pub. Date: Apr. 17, 2025

(54) SHIELDED ELECTRICAL WIRE

(71) Applicant: SUMITOMO ELECTRIC INDUSTRIES, LTD., Osaka (JP)

(72) Inventors: Yuhei MAYAMA, Tochigi (JP); Hitoshi ENDO, Tochigi (JP); Hiroyuki OKAWA, Tochigi (JP); Yuji OCHI, Tochigi (JP)

(73) Assignee: SUMITOMO ELECTRIC INDUSTRIES, LTD., Osaka (JP)

(21) Appl. No.: 18/899,143

(22) Filed: Sep. 27, 2024

(30) Foreign Application Priority Data
Oct. 11, 2023 (JP) 2023-176228

(51) Int. Cl. H01B 3/30; H01B 7/02; H01B 17/62

(52) U.S. Cl. CPC H01B 3/302; H01B 7/0225; H01B 17/62

(57) ABSTRACT

A shielded electrical wire includes an inner conductor, an insulator covering the inner conductor, a shield conductor covering the insulator, and an outer sheath covering the shield conductor. A cross-sectional area of the inner conductor is 3 mm² to 160 mm². The insulator contains polyolefin as a resin. The outer sheath contains polyurethane as a resin.

### CROSS REFERENCE TO RELATED APPLICATIONS

This application claims priority based on Japanese Patent Application No. 2023-176228 filed on Oct. 11, 2023, and the entire contents of the Japanese patent application are incorporated herein by reference.

### TECHNICAL FIELD

The present disclosure relates to a shielded electrical wire.

### BACKGROUND

Patent literature (Japanese Unexamined Patent Application Publication No. 2014-139932) discloses an electric cable in which an outer circumference of a conductor is covered with an insulating resin including a flame retardant, and further discloses a shield conductor covering an outer circumference of the insulating resin and the outer circumference of the shield conductor is covered with an insulating resin.

### SUMMARY

A shielded electrical wire of the present disclosure includes an inner conductor, an insulator covering the inner conductor, a shield conductor covering the insulator, and an outer sheath covering the shield conductor. A cross-sectional area of the inner conductor is 3 mm² to 160 mm². The insulator contains polyolefin as a resin. The outer sheath contains polyurethane as a resin.

### BRIEF DESCRIPTION OF THE DRAWINGS

FIG. 1 is a cross-sectional view of a shielded electrical wire according to an aspect of the present disclosure, taken along a plane perpendicular to a longitudinal axis.

FIG. 2 is a table showing a configuration of the shielded electrical wire and an evaluation result.

### DETAILED DESCRIPTION

Since vibration is continuously applied to an automobile during traveling or the like, an electrical wire mounted on an automobile is required to have vibration resistance capable of reducing wear or the like of an outer sheath and a decrease in pressure resistance characteristics when vibration is repeatedly applied.

An object of the present disclosure is to provide a shielded electrical wire having excellent vibration resistance.

Embodiments will be described below.

### Description of Embodiments of Present Disclosure

First, embodiments of the present disclosure will be listed and described. In the following description, the same or corresponding elements are denoted by the same reference signs, and the same description thereof will not be repeated.

(1) A shielded electrical wire according to an aspect of the present disclosure includes an inner conductor, an insulator covering an outer side of the inner conductor, a shield conductor covering the insulator, and an outer sheath covering the shield conductor. A cross-sectional area of the inner conductor is 3 mm² to 160 mm². The insulator contains polyolefin as a resin. The outer sheath contains polyurethane as a resin.

By setting the cross-sectional area of the inner conductor to 3 mm² or more, the resistance of the inner conductor can be reduced, and a high current can be supplied.

By setting the cross-sectional area of the inner conductor to be 160 mm² or less, the flexibility of the inner conductor or a shielded electrical wire including the inner conductor (hereinafter, also simply referred to as “electrical wire”) can be increased, and the weight of the electrical wire can be reduced.

The insulator contains polyolefin as a resin, and thus the flexibility of the electrical wire can be increased.

The outer sheath contains polyurethane as a resin, and thus the vibration resistance of the electrical wire can be increased.

(2) In the above (1), the outer sheath and the insulator each may contain a flame retardant.

The outer sheath and the insulator contain the flame retardant, and thus the of the electrical wire can be enhanced.

(3) In the above (1) or (2), the polyurethane of the outer sheath may be cross-linked.

The polyurethane of the outer sheath is cross-linked, and thus the heat resistance of the outer sheath and the electrical wire can be improved.

(4) In any one of the above (1) to (3), the polyolefin of the insulator may be cross-linked.

The polyolefin of the insulator is cross-linked, and thus the heat resistance of the insulator and the electrical wire can be improved.

(5) In any one of the above (1) to (4), in a cross-section perpendicular to a longitudinal axis, the insulator and the outer sheath may be disposed such that an outer circumference of the insulator and an outer circumference of the outer sheath form concentric circles.

By disposing the outer circumference of the insulator and the outer circumference of the outer sheath to form concentric circles in the cross-section perpendicular to the longitudinal axis, the shielded electrical wire according to an aspect of the present disclosure can be suitable for applications with rated voltages of several hundred volts.

(6) In any one of the above (1) to (5), a thickness of the insulator may be 0.4 mm or more.

By setting the thickness of insulator to be 0.4 mm or more, the voltage resistance characteristics of the shielded electrical wire can be enhanced.

### DETAILS OF EMBODIMENTS OF PRESENT DISCLOSURE

Specific examples of shielded electrical wires according to one embodiment of the present disclosure (hereinafter referred to as “the embodiment”) will be described below with reference to the drawings. The present invention is not limited to these examples, but is defined by the scope of the claims, and is intended to include all modifications within the meaning and scope equivalent to the scope of the claims.

### [Shielded Electrical Wire]

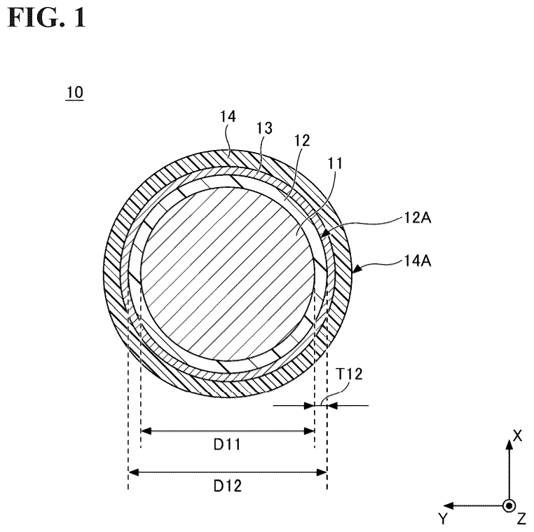

FIG. 1 shows an example of a configuration of a cross-section perpendicular to a longitudinal axis of the shielded electrical wire of the embodiment. In FIG. 1, a longitudinal axis of an electrical wire 10 is along the Z-axis, i.e., the axis perpendicular to the plane of the paper. FIG. 1 shows a cross-section in an XY plane perpendicular to the Z-axis.

As shown in FIG. 1, electrical wire 10 of the embodiment includes an inner conductor 11, an insulator 12 disposed on an outer side of inner conductor 11, a shield conductor 13 disposed on an outer side of insulator 12, and an outer sheath 14 disposed on an outer side of shield conductor 13.

### (1) Each Member Contained in Electrical Wire

Each member contained in the electrical wire of the embodiment will be described.

### (1-1) Inner Conductor

FIG. 1 is a schematic view, and inner conductor 11 is represented by a single circle in FIG. 1. Inner conductor 11 is not limited to such a form.

Inner conductor 11 may include a single conductor element wire or a plurality of conductor element wires.

The cross-sectional shape of inner conductor 11 is not particularly limited, and for example, a surface perpendicular to a longitudinal axis may be a circle such as a perfect circle or an ellipse, or may be a polygon such as a quadrangle.

From the viewpoint of improving ease of handling during wiring, etc., electrical wire 10 may be required to have flexibility which is a property that allows electrical wire 10 to be easily bent. When electrical wire 10 is required to have flexibility, inner conductor 11 may be a stranded wire formed by stranding a plurality of conductor element wires. When inner conductor 11 includes a stranded wire formed by stranding a plurality of conductor element wires, the number of conductor element wires included in inner conductor 11 and stranding conditions are not particularly limited, and may be selected according to the conductor cross-sectional area and the like required for inner conductor 11.

A material of inner conductor 11 is not particularly limited, and for example, one or more conductor materials selected from copper alloy, copper, silver-plated annealed copper, and tin-plated annealed copper may be used. As copper, for example, annealed copper may be used.

A cross-sectional area of inner conductor 11 is not particularly limited, but the cross-sectional area of inner conductor 11 may be 3 mm² or more, and may be 8 mm² or more. By setting the cross-sectional area of inner conductor 11 to be 3 mm² or more, the resistance of inner conductor 11 can be reduced, and a high current can be supplied.

An upper limit of the cross-sectional area of inner conductor 11 is not particularly limited, but the cross-sectional area of inner conductor 11 may be 160 mm² or less. By setting the cross-sectional area of inner conductor 11 to be 160 mm² or less, the flexibility of inner conductor 11 and electrical wire 10 including inner conductor 11 can be increased, and the weight of electrical wire 10 can be reduced.

As described above, the cross-sectional area of inner conductor 11 may be set to 3 mm² to 160 mm², and may be set to 8 mm² to 160 mm².

The cross-sectional area of inner conductor 11 can be evaluated by the following procedure when inner conductor 11 is a stranded wire.

First, a wire diameter of the conductor element wire of inner conductor 11 is measured. Then, the cross-sectional area of inner conductor 11 is obtained by multiplying the cross-sectional area of the conductor element wire obtained from the wire diameter by the number of conductor element wires included in inner conductor 11.

When inner conductor 11 is a single wire, the cross-sectional area of inner conductor 11 can be obtained from a measured outside diameter D11 of inner conductor 11.

The wire diameter is obtained by measuring the diameters of two orthogonal wires in any cross-section perpendicular to the longitudinal axis of the conductor element wire and averaging the two measured diameters. Outside diameter D11 of inner conductor 11 in the case of inner conductor 11 being a single wire is also obtained by the same procedure as in the case of the wire diameter, except that inner conductor 11 is the measurement target.

### (1-2) Insulator

Insulator 12 may cover the outer surface of inner conductor 11 as shown in FIG. 1. Insulator 12 may include a resin.

### (1-2-1) Resin

Insulator 12 may contain polyolefin as a resin. Insulator 12 contains polyolefin as the resin, and thus the flexibility of electrical wire 10 can be increased.

As the polyolefin, for example, one or more kinds selected from homopolymers such as low density polyethylene (LDPE), linear low density polyethylene (L-LDPE), and very low density polyethylene (VLDPE), and copolymers such as ethylene-ethyl acrylate copolymer (EEA), ethylene-methyl acrylate copolymer (EMA), and ethylene-vinyl acetate copolymer (EVA) in each of which a monomer having a polarity other than α-olefin is introduced to impart flexibility to the resin may be used.

For example, EEA may be used as the polyolefin for insulator 12. EEA has a low crystallinity due to ethyl acrylate (EA) contained therein, and thus has high flexibility. Further, EEA has a high thermal decomposition starting temperature of 300° C. and has high long-term aging heat resistance among polyolefins, and thus can be used for a long period of time as an electrical wire that generates heat when energized. Further, EEA easily forms a carbonized layer during combustion, and the carbonized layer blocks oxygen and inhibits combustion. Thus, it is easy to achieve high flame retardancy with a low specific gravity by reducing the amount of flame retardant added.

The resin may have a comonomer content of, for example, 23% by weight or more, which reduces crystallinity and particularly enhances the flexibility of insulator 12 and electrical wire 10. The resin contained in insulator 12 may be a copolymer of an olefin and a polar comonomer, or a mixture of the copolymer, an olefin, and an α-olefin copolymer.

### (1-2-2) Flame Retardant

Insulator 12 may also contain a flame retardant. Insulator 12 contains the flame retardant, and thus the flame retardancy of insulator 12 and electrical wire 10 can be enhanced.

As the flame retardant, one or more selected from non-halogen-based flame retardants and halogen-based flame retardants may be used.

Examples of the non-halogen-based flame retardant include metal hydroxides (magnesium hydroxide and the like), nitrogen-based flame retardants (melamine cyanurate and the like), antimony trioxide, and phosphorus-based flame retardants (red phosphorus, phosphate esters, and the like).

Examples of the halogen-based flame retardant include bromine flame retardant.

In this specification, the flame retardancy can be evaluated by a 45-degree inclination flame retardancy test of ISO19642 standard. As a procedure of the 45-degree inclination flame retardancy test, first, an electrical wire cut out to 600 mm is used as a sample, and the sample is fixed in a state of being inclined at an angle of 45 degrees with respect to a horizontal plane. Next, a flame of a gas burner is brought into contact with the sample at a position 500 mm away from the upper end of the sample, and the flame contact is terminated when the conductors are exposed or after a lapse of 30 seconds. The time from the end of the flame contact to self-extinguishing of the sample is measured. When the sample self-extinguishes within 70 seconds and the insulator remains at least 50 mm from the upper end of the sample, the sample is deemed to have passed and it can be determined that the sample has flame retardancy. When the sample does not self-extinguish within 70 seconds, or when the insulator does not remain at least 50 mm or more from the upper end of the sample, the sample is deemed to have failed and it can be determined that the sample has flame retardancy.

### (1-2-3) Other Additive Components

Insulator 12 may contain, in addition to the resin and the flame retardant, one or more additive components selected from an antioxidant, a deterioration inhibitor, an acid acceptor, a coloring agent, a cross-linking agent, a cross-linking auxiliary agent, a processing aid, a filler, a lubricant, and the like.

Insulator 12 may be formed by adding a flame retardant or other additive components to the resin as necessary and extruding the resin around the outer circumference of inner conductor 11.

The polyolefin of insulator 12 may be cross-linked by irradiation with ionizing radiation (γ-rays, electron beams, or the like) or chemical cross-linking such as peroxide cross-linking or silane cross-linking after being coated on the outer surface of inner conductor 11.

The polyolefin of insulator 12 may be non-cross-linked or cross-linked. The polyolefin of insulator 12 is cross-linked, and thus the heat resistance of insulator 12 and electrical wire 10 can be improved.

A thickness T12 of insulator 12 is not particularly limited, but may be, for example, 0.32 mm or more, and may be 0.4 mm or more.

By setting thickness T12 of insulator 12 to be 0.32 mm or more, and particularly 0.4 mm or more, the voltage resistance characteristics of the shielded electrical wire can be improved.

An upper limit of thickness T12 of insulator 12 is not particularly limited, but may be, for example, 1.6 mm or less. By setting thickness T12 of insulator 12 to be 1.6 mm or less, the shielded electrical wire can be made lightweight and easily bendable. Thus, the ease of handling of the shielded electrical wire can be improved. Thickness T12 of insulator 12 may be selected according to the cross-sectional area of inner conductor 11. For example, when the cross-sectional area of inner conductor 11 is 160 mm², thickness T12 of insulator 12 may be set to 1.6 mm.

Thus, thickness T12 of insulator 12 may be, for example, 0.32 mm to 1.6 mm, and may be 0.4 mm to 1.6 mm.

Thickness T12 of insulator 12 is obtained by subtracting outside diameter D11 of inner conductor 11 from an outside diameter D12 of insulator 12 and dividing the result by 2. Outside diameter D12 of insulator 12 and outside diameter D11 of inner conductor 11 are obtained by the same procedure as in the case of the wire diameter described for the inner conductor, except that insulator 12 and inner conductor 11 are measurement target, and thus description thereof will be omitted.

### (1-3) Shield Conductor

Electrical wire 10 of the embodiment may have shield conductor 13 disposed on the outer side of insulator 12.

Shield conductor 13 may include a conductive material.

Shield conductor 13 may have a configuration in which a conductive tape including a conductive layer is spirally wound along a longitudinal axis of inner conductor 11, for example.

In this case, the conductive tape may include a base material and a conductive layer disposed on at least one of the upper surface and the lower surface of the base material. The conductive tape may have conductive layers on both the upper surface and the lower surface of the base material. The conductive tape may be formed of only the conductive layer without the base material.

A material of the conductive layer is not particularly limited, but may include a metal, and may be, for example, a metal foil. When the conductive layer contains a metal, the material of the metal is not particularly limited, and for example, copper, a copper alloy, aluminum, an aluminum alloy, or the like may be used.

A material of the substrate is not particularly limited, and may include, for example, an insulating material such as an organic polymer material or a nonwoven fabric. Examples of the organic polymer material include polyester resins such as polyethylene terephthalate (PET), polyolefin resins such as polypropylene, and vinyl resins such as polyvinyl chloride. The base material may be a base material containing an insulating material, or may be a base material made of only an insulating material.

Shield conductor 13 may also have a configuration that includes a metal element wire. In this case, shield conductor 13 may have a configuration in which the metal element wire is transversely wound or braided. As a material of the metal element wire, copper, aluminum, copper alloy, or the like may be used. The metal element wire may be plated with silver or tin on the surface. Thus, for example, a silver-plated copper alloy, a tin-plated copper alloy, or the like may be used as the metal element wire.

When Shield conductor 13 is formed by braiding metal element wires, the flexibility of electrical wire 10 can be increased.

Shield conductor 13 may have not only one layer but also a plurality of layers. When shield conductor 13 has a plurality of layers, for example, shield conductor 13 may have a first shield conductor formed by spirally winding a conductive tape along the longitudinal axis of inner conductor 11 and a second shield conductor formed by transversely winding or braiding a metal element wire. “The first and the second” of the first shield conductor and the second shield conductor are given to identify members, and do not indicate priority, arrangement, and the like.

Electrical wire 10 includes shield conductor 13, and thus it is possible to reduce signal leakage from electrical wire 10 to the outside and radio wave intrusion into a signal or the like transmitted by electrical wire 10 from the outside.

### (1-4) Outer Sheath

Outer sheath 14 may be disposed on the outer side of shield conductor 13.

Electrical wire 10 includes outer sheath 14, and thus inner conductor 11 and shield conductor 13 can be protected. Outer sheath 14 may contain a resin.

### (1-4-1) Resin

Outer sheath 14 may contain polyurethane as a resin.

The polyurethane is not particularly limited, but for example, an ether-based polyurethane elastomer may be used. The properties of the polyurethane are not particularly limited, and for example, polyurethane having a Shore A hardness of 80 to 95 may be used. In particular, from the viewpoint of improving strength and low-temperature characteristics, polyurethane having a Shore A hardness of about 85, for example, 83 to 87 may be used.

In a conventional shielded electrical wire, polyolefin is generally used as a resin for an outer sheath. The shielded electrical wire using polyolefin as the resin for the outer sheath can also have a sufficient vibration resistance satisfying the standard of the shielded electrical wire. However, the shielded electrical wire using polyolefin as the resin for the outer sheath has often been used by being disposed in a tubular protection member in consideration of wear of the outer sheath due to long-term use. When the shielded electrical wire is disposed in the tubular protection member, a space for the protection member is also required when the shielded electrical wire is installed. As automobiles become more electrically driven, it is also required to reduce a space for installing electrical wires. Thus, there is a demand for a shielded electrical wire with further improved vibration resistance.

As a result of studies conducted by the inventors of the present invention, the vibration resistance of electrical wire 10 can be increased by outer sheath 14 containing polyurethane as the resin, as compared with a shielded electrical wire in which polyolefin is used as the resin for the outer sheath. Further, since outer sheath 14 contains polyurethane as the resin, outer sheath 14 can be made thin, and the outside diameter of electrical wire 10 can be reduced, the weight of electrical wire 10 can be reduced, and the flexibility can be increased.

In this specification, the vibration resistance can be evaluated by performing a vibration test (sinusoidal constant vibration test) on the shielded electrical wire under the conditions of a number of vibrations of 10 Hz, an accelerated velocity of 4.5 G (44.13 m/s²), and a time of 3 hours in an environment at a temperature of 60° C.

The appearance of the shielded electrical wire after the vibration test is visually checked, and a pressure resistance test is performed for one minute in 3 kV. The pressure resistance test can be performed under the conditions of 3 kVAC in water for 1 minute by a method in conformity with 4.6 (voltage resistance) of JIS C 3005 (2014).

The shielded electrical wire after the vibration test can be evaluated as a shielded electrical wire having excellent vibration resistance when the outer sheath completely covers the shield conductor as a result of the appearance test and the shielded electrical wire passes the pressure resistance test.

The shielded electrical wire after the vibration test can be evaluated as a shielded electrical wire having insufficient vibration resistance when the outer sheath is partially broken or the shield conductor is exposed as a result of the appearance test, or the shielded electrical wire fails the pressure resistance test.

### (1-4-2) Flame Retardant

Outer sheath 14 may also contain a flame retardant. Outer sheath 14 contains the flame retardant, and thus the flame retardancy of outer sheath 14 and electrical wire 10 can be enhanced.

The same material as the material described for insulator 12 may be used as the flame retardant, and thus the description thereof is omitted.

### (1-4-3) Other Additive Components

Outer sheath 14 may contain, in addition to the resin and the flame retardant, additives such as an antioxidant, a deterioration inhibitor, an acid acceptor, a coloring agent, a cross-linking agent, a cross-linking auxiliary agent, a processing aid, a filler, and a lubricant.

Outer sheath 14 may be formed by adding a flame retardant or other additive components to a resin as necessary and extruding the resin on an outer circumference of shield conductor 13.

The polyurethane of outer sheath 14 may be cross-linked by irradiation with ionizing radiation (γ-rays, electron beams, or the like) or chemical cross-linking such as peroxide cross-linking or silane cross-linking after being coated on the outer surface of shield conductor 13.

The polyurethane of outer sheath 14 may be non-cross-linked or cross-linked. The polyolefin of outer sheath 14 is cross-linked, and thus the heat resistance of outer sheath 14 and electrical wire 10 can be improved.

### (2) Cross-Sectional Structure of Shielded Electrical Wire

As shown in FIG. 1, in a cross-section perpendicular to the longitudinal axis of electrical wire 10, insulator 12 and outer sheath 14 may be disposed such that an outer circumference 12A of insulator 12 and an outer circumference 14A of outer sheath 14 form concentric circles. That is, insulator 12 and outer sheath 14 may be disposed so as to surround one inner conductor 11.

The above-mentioned “disposed such that an outer circumference 12A of insulator 12 and an outer circumference 14A of outer sheath 14 form concentric circles” does not have a geometrically strict meaning, and includes, for example, a case where the center of outer circumference 12A of insulator 12 and the center of outer circumference 14A of outer sheath 14 are shifted from each other within a range of an error allowed in manufacturing. When outer circumference 12A of insulator 12 and outer circumference 14A of outer sheath 14 include irregularities, outer circumference 12A of insulator 12 and outer circumference 14A of outer sheath 14 may be disposed such that the minimum circles of outer circumference 12A of insulator 12 and outer circumference 14A of outer sheath 14 form concentric circles.

In a cross-section perpendicular to the longitudinal axis of electrical wire 10, insulator 12 and outer sheath 14 are disposed such that outer circumference 12A of insulator 12 and outer circumference 14A of outer sheath 14 form concentric circles, so that electrical wire 10 of the embodiment can be suitable for a rated voltage application of several hundred volts.

### EXAMPLES

The present invention will be described below with reference to specific examples, but the present invention is not limited to these examples.

### (Evaluation Method)

First, a method for evaluating electrical wires produced in the following experimental examples will be described.

### (1) Vibration Resistance

The test method of the vibration resistance has been described, and thus the description of the test method will be omitted.

The shielded electrical wire after the vibration test was evaluated as A, which means that the shielded electrical wire had excellent vibration resistance, when the outer sheath completely covered the shield conductor as a result of the appearance test and passed the pressure resistance test.

The shielded electrical wire after the vibration test was evaluated as B, which means that the shielded electrical wire had insufficient vibration resistance, when the outer sheath was partially broken and the shield conductor was exposed as a result of the appearance test, or when the shielded electrical wire failed the pressure resistance test.

### (2) Flame Retardancy Test

The test method for the flame retardancy test has been described, and thus the description of the test method will be omitted.

As a result of the flame retardancy test, when the sample self-extinguished within 70 seconds and the insulator remained at least 50 mm from the upper end of the sample, the sample was evaluated as A, which means that the sample was a shielded electrical wire having flame retardancy.

As a result of the flame retardancy test, when the sample did not self-extinguish within 70 seconds or when the insulator did not remain at least 50 mm from the upper end of the sample, the sample was evaluated as B, which means that the sample was a shielded electrical wire having insufficient flame retardancy.

### (3) Cyclic Bending Resistance Test

In the cyclic bending resistance test, the shielded electrical wire was bent a number of times until it was broken, using a test method specified in ISO19642-2. The diameter of the mandrel is five times the outer diameter of the shielded electrical wire. The load was 1 kg/mm² per cross-sectional area of the inner conductor, and was 12 kg at the maximum. For example, if the cross-sectional area of the inner conductor was 3 mm², the load was 3 kg. The number of bending times until breakage was evaluated as C for less than 1,000 times, B for 1,000 times or more and less than 5,000 times, and A for 5,000 times or more.

### (Manufacturing Conditions of Electrical Wire)

The electrical wire in each experimental example will be described below. The experimental example 1 is a comparative example, and the experimental examples 2, 3, 4, 5, 6, 7 and 8 are examples.

### Experimental Examples 1 to 8

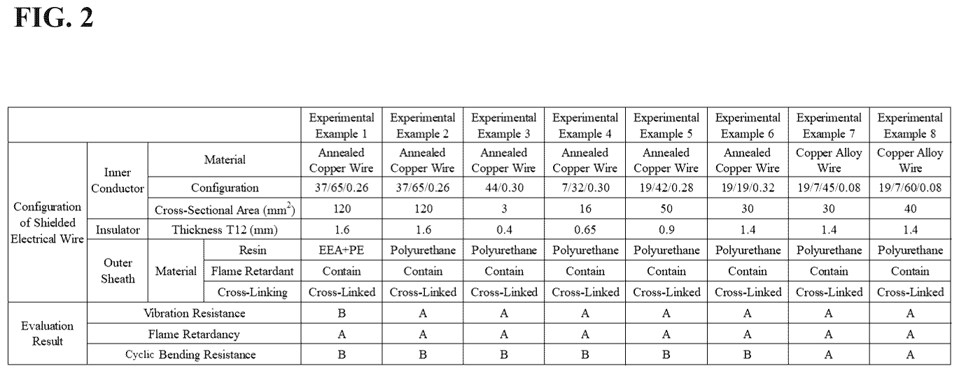

Electrical wires having the cross-sectional structure shown in FIG. 1 and the configuration shown in FIG. 2 were produced and evaluated. The evaluation results are shown in FIG. 2.

The notation “37/65/0.26” or the like in the column of “Configuration” of the inner conductor shown in FIG. 2 means that 65 conductor element wires having a wire diameter of 0.26 mm are twisted to form a stranded wire, and 37 stranded wires are further twisted to form the inner conductor.

In each of the experimental examples, insulator 12 contains, as a main component, a resin in which ethylene-ethyl acrylate copolymer (EEA) and polyethylene (PE) are mixed so that the mass ratios of EEA and PE are substantially the same, and also contains a flame retardant. The resin of insulator 12 is cross-linked.

In addition, in all of the experimental examples, shield conductor 13 disposed between insulator 12 and outer sheath 14 has a configuration in which tin-plated annealed copper wires are braided.

In the experimental example 1, the same resin is used for insulator 12 and outer sheath 14.

As shown in FIG. 2, it was confirmed that the electrical wires of experimental examples 2, 3, 4, 5, 6, 7, and 8 in which the outer sheath contained polyurethane as a resin had excellent vibration resistance regardless of the cross-sectional area of inner conductor 11. Further, it was confirmed that the electrical wires of experimental examples 7 and 8 in which the inner conductor was formed of copper alloy had high cyclic bending resistance.

What is claimed is:

1. A shielded electrical wire comprising:
an inner conductor;
an insulator covering the inner conductor;
a shield conductor covering the insulator; and
an outer sheath covering the shield conductor,
wherein a cross-sectional area of the inner conductor is 3 mm² to 160 mm²,
wherein the insulator contains polyolefin as a resin, and
wherein the outer sheath contains polyurethane as a resin.

2. The shielded electrical wire according to claim 1,
wherein the outer sheath and the insulator each contain a flame retardant.

3. The shielded electrical wire according to claim 1,
wherein the polyurethane of the outer sheath is cross-linked.

4. The shielded electrical wire according to claim 1,
wherein the polyolefin of the insulator is cross-linked.

5. The shielded electrical wire according to claim 1,
wherein, in a cross-section perpendicular to a longitudinal axis of the shielded electrical wire, the insulator and the outer sheath are disposed such that an outer circumference of the insulator and an outer circumference of the outer sheath form concentric circles.

6. The shielded electrical wire according to claim 1,
wherein a thickness of the insulator is 0.4 mm or more.
